(19) United States
(12) Patent Application Publication
(10) Pub. No.: US 2002/0018842 A1
(43) Pub. Date: Feb. 14, 2002

(54) Method and system for producing pelletized fuzzy cottonseed with cotton fibers replacing lint within the cottonseed

(76) Inventor: Ernest Michael Dunlow, Roanoke Rapids, NC (US)

Correspondence Address: Michael I. Kroll, 171 Stillwell Lane, Syosset, NY, 11791, US

(21) Appl. No.: 09/860,683

(22) Filed: May 19, 2001

Related U.S. Application Data
(63) Continuation-in-part of application No. 09/585,795, filed on Jun. 3, 2000, now Pat. No. 6,322,845.

(51) Int. Cl. A23K 1/00

(52) U.S. Cl. 426/630; 426/72

(57) ABSTRACT

A method and system for producing pelletized whole fuzzy cottonseed from whole fuzzy cottonseed. The method includes the steps of removing lint from the cottonseed and replacing the lint with cotton fibers. The cottonseeds including the added cotton fibers are minced into a cottonseed mash in the screw extruder. The mash is then pelletized to form palletized cottonseeds. The cotton fibers added are at least one of gin waste, textile waste and low grade cotton fiber. Prior to removing the lint the cottonseeds are stored in a holding bin prior to removing the lint. A metered amount of cottonseed is provided to the screw extruder. After palletizing the cottonseeds, the pellets are cooled to reduce their temperature and stored. The cottonseeds may be enriched prior to palletizing with at least one of feed additives, vitamins and medicines. After palletizing the cottonseeds may be coated, for example, with an insecticide for protecting the pelletized cottonseed from insects and rodents.

### REFERENCE TO RELATED APPLICATIONS

This application is a Continuation-in-Part Application of U.S. patent application Ser. No. 09/585,795 filed on Jun. 3, 2000.

### BACKGROUND OF THE INVENTION

1. Field of the Invention

The present invention relates generally to fuzzy cottonseed processing and, more specifically, to a method of producing pelletized whole fuzzy cottonseed wherein an amount of lint is removed from the cottonseed and replaced with a lesser grade cotton fiber prior to grinding and palletizing the cottonseed.

2. Description of the Prior Art

Numerous processes for forming food products from cottonseed have been provided in the prior art. For example, U.S. Pat. Nos. 2,168,532; 3,972,861, 4,022,915; 4,034,120; 4,055,680; 4,062,988; 4,084,007; 4,132,807; 4,201,709; 4,279,8 11; 5,204,102;

While these processes for forming food products from cottonseed may be suitable for the purposes for which they were designed, they would not be as suitable for the purposes of the present invention, as hereinafter described.

This patent relates to improvements in the palletizing of materials, especially feedstuffs and fertilizers. The object of this invention is to facilitate the operation of converting coarsely ground or pulverized materials into the form of pellets, reduce the power required for pelleting, reduce the wear and tear on the machinery with its accompanying repair expense, increase the capacity of extrusion machines and to make a product having an improved glossy appearance and less tendency to crumble.

An edible high-protein flour is produced by an improved process. Cottonseed meats are dried, and then comminuted in a wide chamber mill having certain specifications which prevent rupturing the pigment glands of the cottonseed. This improvement is correlated with liquid cyclone separation followed by solids recovery steps, thus comprising an improved process which consistently yields an edible cottonseed protein concentrate.

A method of producing an expanded intermediate moisture food product having a moisture content between about 20 and 30 percent by weight, a protein content of between about 15 and 35 percent by weight, and a water activity between about 0.80 and 0.85 that has an extended shelf life without refrigeration is provided, comprising admixing a dry granular cereal grain, dry protein source material, together with other powdered and granular materials, a polyhydroxy alcohol bacteriostatic agent and an antimycotic compound to produce a homogeneous blend; passing said admixture in a confined stream through a precooking zone and subjecting it to treatment with steam, hot water and agitation to produce a hot, granular blend having a moisture content of about 25 percent and a temperature of about 190.degree. F.; passing the wet blend into a compression and extrusion zone wherein the blend is subjected to temperatures above the boiling point of water for a time sufficient to cook the admixture while maintaining the admixture under superatmospheric pressures; extruding the fused cooked admixture through a die into a zone of reduced pressure to form a continuous stream of expanded cooked product; continuously dividing the expanded cooked product into discrete pellets of uniform shape; passing the pellets to a cooling zone and subjecting the pellets to a spray of cold air and water until their temperature is reduced to 100.degree. F., or less, and the moisture content of the pellets is raised to a predetermined level; and coating the cooled pellets with liquefied fat.

The pelleting of fibrous agricultural material, such as beet pulp is facilitated by the incorporation of a mixture of expanded vermiculite and/or finely divided vermiculite ore with an organic material which may be animal fat or a vegetable oil product such as cottonseed oil.

Lint removed from cottonseed by dry acid is compacted by pelletizing in a standard pellet mill.

Molasses, a fatty acid soap former such as yellow grease, a hard metallic soap former such as calcium oxide and a natural protein source such as cottonseed meal are blended and mixed to obtain a nutrient composition which sets to a hard block.

An improved process for producing a high quality, edible meal product from cottonseed by releasing oil under conditions whereby unruptured gossypol cells are loated out with the oil flow and immediately separated from the remaining solids. Sufficient gossypol is removed in the cooking step of the extraction phase by a simple, low temperature heat and moisture treatment so that the final meal product rendered is safe and nutritious for human consumption, yet produced at lower cost than prior art methods. The dry, decortiated oleaginous material is treated in a flow down cooker where heat and moisture are added for removal of a significant portion of the oil and gossypol therein, after which the material is mixed with a solvent for removal of the major portion of the remaining oil and gossypol. The material is then separated from the mixture of solvent and removed oil and gossypol in an extracting or washing apparatus after which the material is treated in a desolventizer or removal of the remaining solvent, leaving a meal with a low gossypol and fat content.

Lint removed from cottonseed by dry acid is compacted by pelletizing in a standard pellet mill.

A low-gossypol, high-protein flour is produced by a process which utilizes conventional solvent extraction equipment with a certain series of steps, culminating at a point where a defatted, milled, cottonseed flour mixture is rendered edible for human consumption by the separation of the gossypol-containing portion.

A low gossypol, high protein cottonseed product is produced by passing cottonseed meal through a certain series of steps utilizing conventional solvent extraction equipment, and culminating at a point where the cottonseed meal is rendered edible—for human consumption and animal feed—by disruption of gossypol glands and xtraction of gossypol pigments.

An animal feedstuff comprising fluffy cotton seed coated with a binder selected from molasses, gum, starch and lignasite in an amount of 1-10% by weight, a filler elected from calcium carbonate, diatomaceous earth, bentonite, lime, kaolin, extruded and textured proteins, ground cereal grains and mixtures thereof in an amount f 10-50% by weight, and animal maintenance additives selected from vitamins, minerals, trace elements, veterinarian products for the prevention, control or radication of disease, and growth stimulating factors in an amount of 0-5% by weight.

A ruminant animal feed comprising whole linty cottonseed and preferably soybeans. The soybeans may be replaced by other oil bearing grains and additional nutrients may be added to the feed. The feed includes the lint of the cottonseed for providing fiber to the animals and has a reduced gossypol content as compared to whole raw cottonseed. A process utilizing an auger extruder is used to work the mixture of cottonseed and soybeans to heat the mixture and thereby cook it without charring the mixture. Subsequent to cooking the mixture is extruded and cooled for forming a meal that is provided to the animals for feed.

A method and apparatus to convert fluffy cotton seed to an animal feedstuff comprises delinting the fluffy cotton seed to remove lint and tails therefrom, coating the elinted cotton seed with a binder, adding a filler to the cotton seed coated with the binder, and drying the coated cotton seed to produce a flowable product. The method and apparatus converts a hitherto waste product to a valuable commercial product.

Linter-bearing cottonseed covered with a coat of starch optionally containing one or more biologically related materials selected from vitamins, feed supplements, oils, fats, urea, rodent repellants, insect repellants, medications, anti-germination agents, and preservatives, and a method of preparing it is taught herein. Starch coated cottonseed is useful as an animal feed and as planting stock. The starch coating allows the cottonseed to be used in conventional feed handling and seed linting equipment.

An improved short-length, high-speed extrusion device (10) is provided with having increased capacities and the capability of producing high quality extrudates with improved density and pellet integrity properties. The device (10) includes an extruder (14) equipped with a peripheral die (20, 118), the latter having die outlet openings (100, 120) oriented generally transverse to the longitudinal axis of the extruder barrel (16). The die (20) has a plurality of axially spaced series (92-98) of openings (100), wherein each series (92-98) has a different number of openings (100). Alternately, the die (118) is of radially enlarged design relative to the extruder barrel (16) and has only a single series of openings (120). In both instances, an internal flow-directing bullet (108, 140) is positioned within the corresponding die (20, 118) in order to smoothly direct flow of product from the outlet (21) of the barrel (16) to the transversely oriented die outlet openings (100, 120).

### SUMMARY OF THE PRESENT INVENTION

The present invention relates generally to fuzzy cottonseed processing and, more specifically, to a method of producing pelletized whole fuzzy cottonseed wherein an amount of lint is removed from the cottonseed and replaced with a lesser grade cotton fiber prior to grinding and palletizing the cottonseed.

A primary object of the present invention is to provide a method of pelletizing cottonseed that will overcome the shortcomings of prior art devices.

Another object of the present invention is to provide a method of pelletizing cottonseed wherein at least a portion of the lint is removed from the whole cottonseed prior to extruding.

A further object of the present invention is to provide a method of palletizing cottonseed wherein the removed lint is replaced by a lesser grade of cotton fiber.

An even further object of the present invention is to provide a method of palletizing cottonseed wherein the removed lint is us ed in the production of cellulose based products.

A still further object of the present invention is to provide a method of palletizing cottonseed wherein the lesser grade of cotton fiber is at least one of gin waste, textile waste or any other type of low grade cotton fiber.

A yet further object of the present invention is to provide a method of pelletizing cottonseed including a device for measuring and controlling the flowrate at which cottonseed moves from a storage device to a screw extruder.

Still yet another object of the present invention is to provide a method of pelletizing cottonseed wherein the screw extruder includes an input port for introducing a predetermined amount of cottonseed and an output port for extruding a predetermined amount of cottonseed.

Another object of the present invention is to provide a method of pelletizing cottonseed wherein the screw extruder includes a bore extending therethrough and decreasing in diameter from the input port to the output port.

Yet another object of the present invention is to provide a method of pelletizing cottonseed wherein the screw extruder includes a helical blade extending therethrough and decreasing in diameter from the input port to the output port.

Still yet another object of the present invention is to provide a method of pelletizing cottonseed wherein the helical blade of the screw extruder is able to grind the cottonseed into a blend mixture.

Another object of the present invention is to provide a method of pelletizing cottonseed wherein the temperature of the cottonseed blend increases during passage from the input port to the output port of the screw extruder.

Yet another object of the present invention is to provide a method of pelletizing cottonseed wherein free cottonseed oil pigment gossypol binds with constituent cottonseed elements thereby reducing the amount of free gossypol.

Still yet another object of the present invention is to provide a method of pelletizing cottonseed wherein a pellet forming mechanism forms pellets from the cottonseed blend.

Another object of the present invention is to provide a method of pelletizing cottonseed wherein the pellet forming mechanism includes an input port for introduction of the cottonseed blend and an output port for delivery of a palletized form of the cottonseed blend.

Yet another object of the present invention is to provide a method of pelletizing cottonseed able to provide a whole cottonseed product that can be handled by traditional grain handling equipment.

Still yet another object of the present invention is to provide a method of pelletizing cottonseed able to produce a whole cottonseed product that does not require the introduction of additives, such as coatings.

Another object of the present invention is to provide a method of pelletizing cottonseed wherein nutritional ingredients are introduced into the blend creation process, the nutritional ingredients permeating throughout the blend pellet.

Yet another object of the present invention is to provide a method of pelletizing cottonseed wherein coatings are applied to cover the palletized cottonseed blend for protect the cottonseed against insect and vermin and extending the shelf life of the pellets.

Another object of the present invention is to provide a method of pelletizing cottonseed that is simple and easy to use.

A still further object of the present invention is to provide a method of pelletizing cottonseed that is economical in cost to manufacture.

Additional objects of the present invention will appear as the description proceeds.

The present invention overcomes the shortcomings of the prior art by providing a method of processing whole fuzzy cottonseed into animal feed pellets. The primary steps of replacing the lint of the cottonseed with a lesser grade cotton fiber, mincing the cottonseed until the hulls have been broken down and increasing the pressure before extruding so that the mixture achieves a mash-like consistency enables the forming of pellets.

These whole fuzzy cottonseed pellets have the same nutritional value as before the pellet process and can be handled by machinery used to process grain products. In addition to the handling capabilities, the pellets are a densified form of whole fuzzy cottonseed as opposed to unprocessed whole fuzzy cottonseed or coated whole fuzzy cottonseed.

Furthermore, because the whole fuzzy cottonseed is reduced to a blend the introduction of enrichments such as, vitamins, feed supplements and medications are able to be absorbed by the pellet and attain a consistency throughout the pellet which is not possible with coated seeds. Also, the use of rodent and insect repellants can be applied as a coating after pelletizing the whole fuzzy cottonseed.

In addition the introduction of binding agents for the cottonseed pigment gossypol would provide a feed of ad libitum intake.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 Is a diagrammatic view of a system used to perform the method of producing pelletized cottonseed of the present invention;

FIG. 2 is a diagrammatic view of a portion of system for performing the method of producing pelletized cottonseed of the present invention able to remove lint and add alternate cotton fibers to the cottonseed;

FIG. 3 is a flow diagram showing the method of producing pelletized whole fuzzy cottonseed of the present invention;

FIG. 4 is a flow diagram illustrating the steps involved in the method of producing pelletized whole fuzzy cottonseed of the present invention; and

FIG. 5 is a flow diagram illustrating the steps involved in the method of producing pelletized whole fuzzy cottonseed of the present invention which are enriched and/or coated.

### LIST OF REFERENCE NUMERALS UTILIZED IN THE DRAWINGS

Turning now descriptively to the drawings, in which similar reference characters denote similar elements throughout the several views, the Figures illustrate the method of palletizing cottonseeds of the present invention. With regard to the reference numerals used, the following numbering is used throughout the various drawing figures.

10 System for accomplishing the method of producing pelletized cottonseed

12 holding bin

14 Saw delinter

16 conduit for passing cottonseed from holding bin to delinter

18 passageway

20 cotton fiber feeder

22 screening device

24 conveyor between screening device and screw extruder

26 screw extruder

28 conveyor for providing cottonseed from screw extruder to pelletizer

30 pelletizer

32 conveyor for providing cottonseed from pelletizer to cooler

34 cooler

36 finished pellet storage container

### DETAILED DESCRIPTION OF THE PREFERRED EMBODIMENT

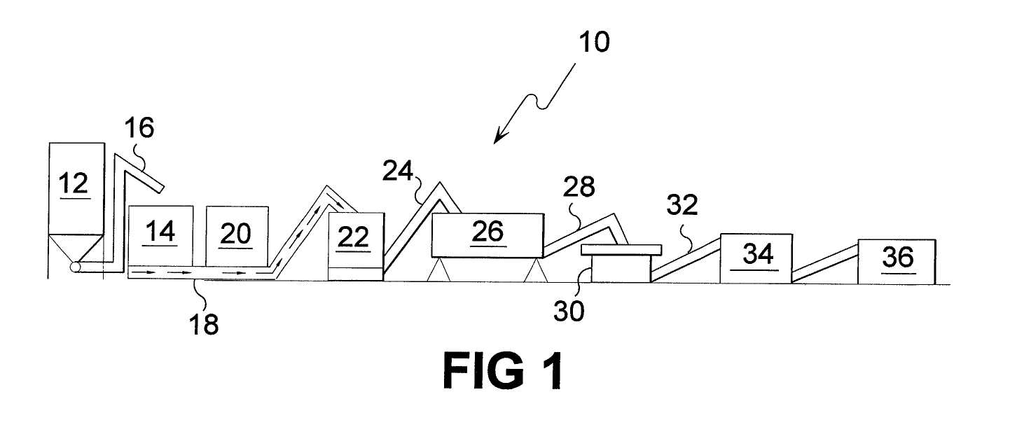

Turning now descriptively to the drawings in which similar reference characters denote similar elements throughout the several views, FIGS. 1 through 4 illustrate the method of producing pelletized whole fuzzy cottonseed of the present invention. A system for performing the method of producing cottonseed is indicated generally by the numeral 10.

The system for performing the method of producing palletized cottonseed 10 is shown in FIG. 1. Cottonseeds which have been ginned are provided to a holding bin 12 for storage until used for producing the pelletized cottonseed. Cottonseeds are the raw material used by the process of the present invention to produce pelletized foodstuffs. The cottonseeds within the holding bin 12 are cleaned and prepared for being put into palletized form by the method of the present invention. The cottonseeds are transported from the holding bin 12 at a predetermined volume to a Saw delinter 14 via a conduit 16. The Saw delinter 14 removes lint from the cottonseeds during passage therethrough. Cottonseeds from which the lint is removed are provided to a passageway 18. The passageway 18 leads past a cotton fiber feeder 20. The cotton fiber feeder 20 adds cotton fibers to the cottonseeds. The added cotton fibers are less valuable and thus less costly than the lint removed by the Saw delinter 14. The cotton fibers added to the cottonseeds are at least any one of gin waste, textile waste or any type of low grade cotton fiber. The lint removed from the cottonseed may be used in the production of cellulose based products. The alternate cotton fibers replacing the lint in the cottonseeds cannot be used in the processes for producing cellulose based products. Preferably, anywhere between 0-240 pounds of lint can be removed from the cottonseeds by the method of the present invention.

The cottonseed including the added cotton fiber is conveyed at a predetermined volume through the passageway 18 to a screening device 22. The screening device 22 removes foreign materials from the cottonseeds. The screened cottonseeds are conveyed via a conveyor 24 to a screw extruder 26. The screw extruder 26 has an input port having a predetermined diameter and an output port having a diameter smaller than the diameter of the input port. The screw extruder 26 gradually decreases in diameter along its length from the input port to the output port. Within the screw extruder 26 is a blade, the blade having a diameter which decreases along its length for placement within the screw extruder 26 and between the input and output ports. The blade of the screw extruder 26 minces the whole fuzzy cottonseeds within the screw extruder 26, thereby increasing the atmospheric pressure as the minced cottonseeds progress towards the output port. The minced mixture under increasing atmospheric pressure crushes the mixture into a whole fuzzy cottonseed mash which has an elevated temperature and is under increasing pressure.

The whole fuzzy cottonseed mash is extruded onto a conveyor 28 for delivery to a pelletizer 30. The pelletizer 30 forms the cottonseed mash into pellets of predetermined sizes. The pellets formed in the pelletizer 30 are then conveyed along a subsequent conveyor 32 to a cooler 34 for reducing the temperature of the pellets. After sufficient temperature reduction, the pellets are provided to a finished pellet storage container 36 where they are stored for future use as feed for animals such as cattle.

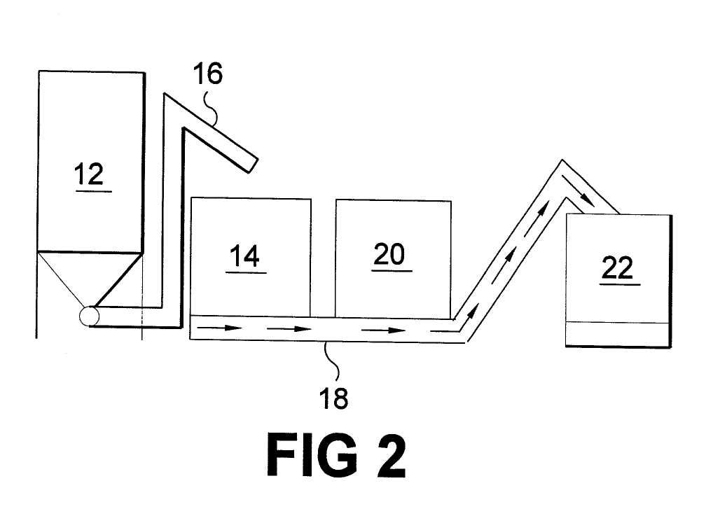

FIG. 2 shows a portion of the method for producing palletized cottonseeds in which the lint is removed from the cottonseeds and replaced with alternate cotton fibers. At this time along the process, the cottonseeds are passed from the holding bin 12 to the Saw delinter 14 via the conduit 16. The Saw delinter 14 removes the lint from the cottonseeds during passage therethrough. Cottonseeds from which the lint is removed are provided to a passageway 18. The passageway 18 leads past a cotton fiber feeder 20. The cotton fiber feeder 20 adds cotton fibers to the cottonseeds. The added cotton fibers are less valuable and thus less costly than the lint removed by the Saw delinter 14. The cotton fibers added to the cottonseeds are at least any one of gin waste, textile waste or any type of low grade cotton fiber. The lint removed from the cottonseeds may be used in the production of cellulose based products. The alternate cotton fibers replacing the lint in the cottonseeds cannot be used in the processes for producing cellulose based products. Preferably, anywhere between 0-240 pounds of lint can be removed from the cottonseeds by the method of the present invention.

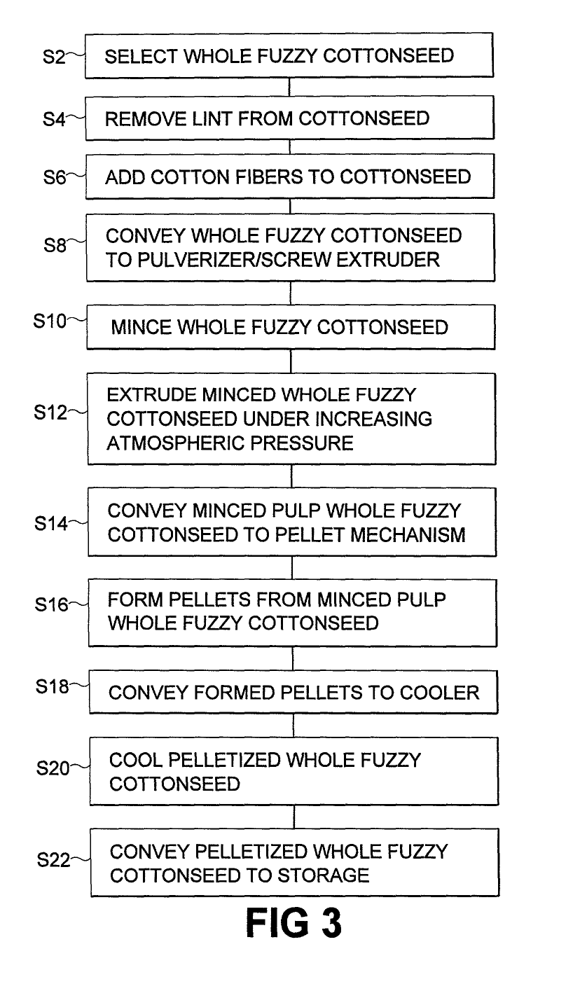

The method of producing palletized cottonseeds will now be described with reference to the figures and specifically FIGS. 3-5. Referring to the flow diagram shown in FIG. 3, the method of turning whole fuzzy cottonseeds into animal feed pellets is described. The cottonseeds which have been ginned include a hull having residual fibers attached thereto. The ginning of cotton results in the removal of all seed material. The seeds can be further processed to cull the most desirable seeds from the seed aggregate for next crop planting. The remainder of the seed aggregate is selected for use in the method of the present invention for producing animal feed. The cottonseeds can not be handled by normal grain handling equipment with the hull attached fibers. These fibers have a tendency to bind with other seed hull fibers and thereby clump together and clog the machinery. The remainder of the seed aggregate having the hull attached is selected and placed within the holding bin 12 as stated in step S2 wherein the cottonseeds are cleaned.

The selected cottonseeds are provided to the delinter 14 wherein lint from the cottonseeds is removed as discussed in step S4. The lint removed from the cottonseeds may be used in the production of cellulose based products. The delinted cottonseeds are provided to the passageway 18 wherein the cottonseeds pass by the cotton fiber feeder 20. The cotton fiber feeder 20 adds lesser grade cotton fibers such as gin waste, textile waste and any other type of low grade cotton fiber as described in step S6. The cottonseeds including the added cotton fiber is conveyed at a predetermined volume through the passageway 18 to a screening device 22. The screening device 22 removes foreign materials from the cottonseed mixture. The screened cottonseed is conveyed via a conveyor 24 to a screw extruder 26.

The screened cottonseeds having the lint replaced with a low grade cotton fiber are metered to the screw extruder 26 as stated in step S8. The metered seeds are minced by a bladed screw in the screw extruder 26 until the seeds and attached fibers have been reduced to a smaller seed particle aggregate as discussed in step S10. The mincing of the cottonseeds by the screw extruder 26 reduces the cottonseeds to a predetermined particle size. As the bladed screw moves the material toward the output port of the screw extruder, the minced seed aggregate is compressed under increasing atmospheric pressure. The increasing atmospheric pressure crushes the seed particle aggregate into a hot whole fuzzy cottonseed mash mixture. The cottonseed mash is then advanced by the screw within the screw extruder 26 to the output port and extruded by the screw extruder 26 as described in step S12. Under ever increasing atmospheric pressure the mixture is compressed causing rupturing. Furthermore, the temperature is caused to increase within the resulting in an extruded mash 40 having an elevated temperature and pressure. The hot oatmeal-like mixture is then conveyed to the pellet forming mechanism 30 as stated in step S14. The pellet forming mechanism 30 forms pellets having a predetermined size from the mixture as discussed in step S16. The hot pellets formed by the pellet forming mechanism 30 are conveyed to the cooler 34 wherein the temperature of the pellets is reduced to a predetermined level as described in steps S18 and 20. The cooler 48 reduces the temperature of the pellets before conveying 50 the pelletized fuzzy cottonseed to the storage container 36 as stated in step S22. The palletized cottonseeds remain in the storage container until they are desired for use.

While the aforementioned method will turn whole fuzzy cottonseed into densified pellets that can be handled in similar fashion as other grain product, it would normally be desirable to enhance the nutritional content of the pellets and to protect the pellets from insects and rodents as will be described hereinafter.

While it has been determined that whole fuzzy cottonseed is a desirable animal feed, the fibers attached to the seeds have prevented their common use as an animal feed. There are products presently available that either coat the seed in a gelatinous starch or subject the seed aggregate to an acid wash to remove the cotton fibers from the seed hulls. Both of these methods increase the processing costs in providing a whole cottonseed feed. The present invention overcomes these undesirable seed aggregate characteristics in a new, novel and cost effective manner.

Mainly the seed aggregate is comprised of hulled seeds having cotton fibers attached thereto. Normal grain handling equipment gets clogged by these fibrous seeds requiring special handling or treatment of the seeds, such as acid baths to remove the fibers. While these methods have been successful for their intended purposes, the present invention provides a natural solution by mincing the seeds and attached fibers into smaller particle matter that is further compressed under pressure to produce a whole fuzzy cottonseed mash that can be formed into pellets.

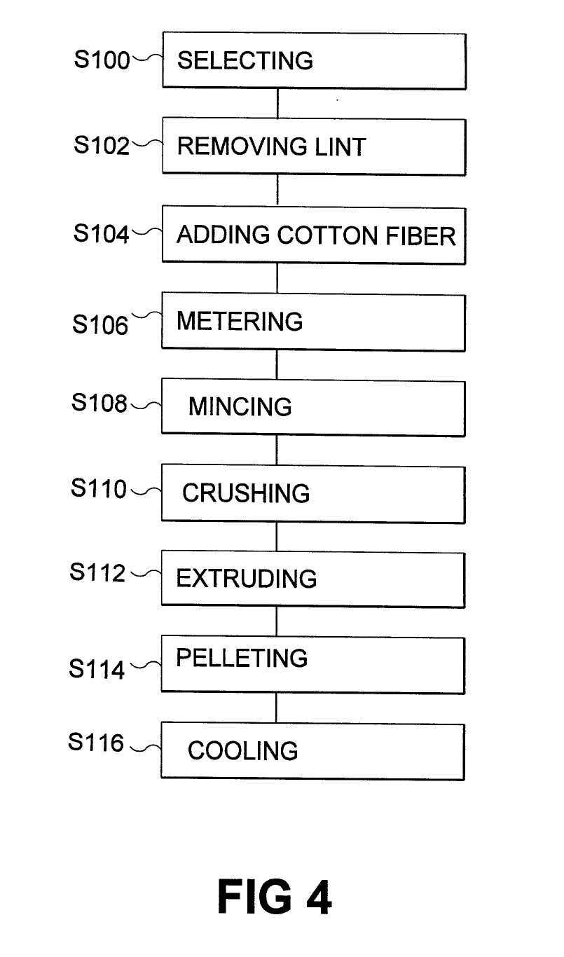

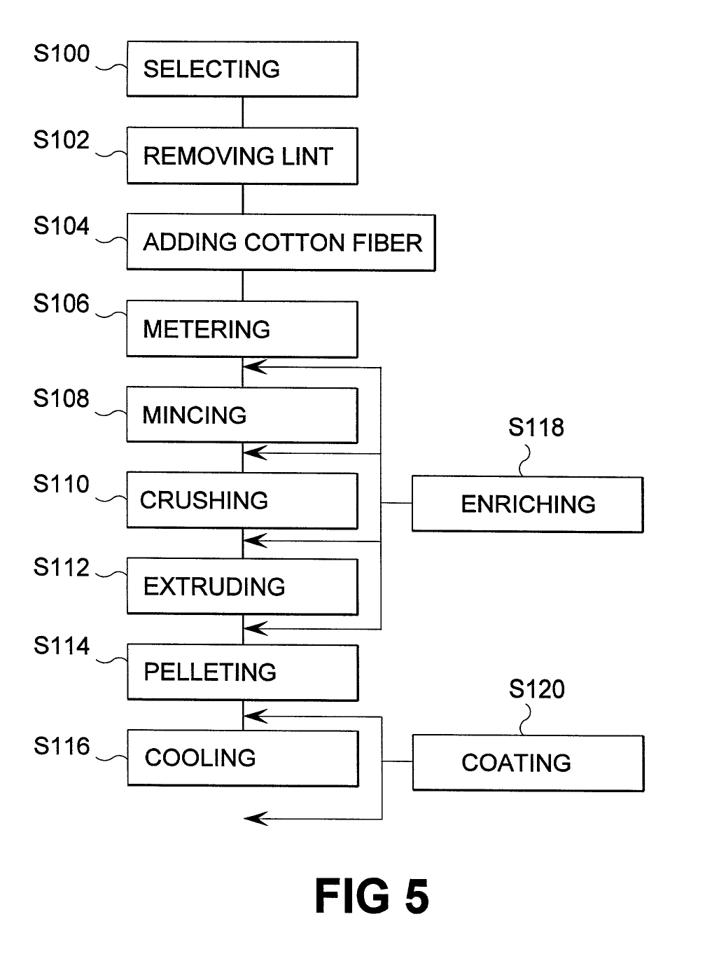

Referring to FIG. 4, the method for producing palletized cottonseed of the present invention is illustrated. FIG. 5 illustrates the method including additional steps for enhancing the pellets by adding feed supplements, vitamins and medicines as well as coating the pellets to protect against insect and vermin infestation. The method of producing palletized cottonseeds is initiated by selecting seeds that have been ginned as stated in step S100. The ginning of cotton results in the removal of all seed material. The seeds can be further processed to cull the most desirable seeds from the seed aggregate for next crop planting. The remainder of the seed aggregate can be used as animal feed.

The selected cottonseeds are provided to the delinter 14 wherein lint from the cottonseeds is removed as discussed in step S102. The lint removed from the cottonseeds may be used in the production of cellulose based products. The delinted cottonseeds are provided to the passageway 18 wherein the cottonseeds pass by the cotton fiber feeder 20. The cotton fiber feeder 20 adds lesser grade cotton fibers such as gin waste, textile waste and any other type of low grade cotton fiber as described in step S104. The cottonseeds including the added cotton fiber is conveyed at a predetermined volume through the passageway 18 to a screening device 22. The screening device 22 removes foreign materials from the cottonseed mixture. The screened cottonseed mixture is conveyed via a conveyor 24 to a screw extruder 26.

The screened cottonseeds having the lint replaced with a low grade cotton fiber are metered at a specific rate to the screw extruder 26 as stated in step S106. The metered seeds are minced by a bladed screw in the screw extruder 26 until the seeds and attached fibers have been reduced to a smaller seed particle aggregate as discussed in step S108. The mincing of the cottonseeds by the screw extruder 26 reduces the cottonseeds to a predetermined particle size. As the bladed screw moves the material toward the output port of the screw extruder, the minced seed aggregate is compressed under increasing atmospheric pressure. The increasing atmospheric pressure crushes the seed particle aggregate into a hot whole fuzzy cottonseed mash as described in step S110. The minced cottonseeds are then advanced by the screw within the screw extruder 26 to the output port and extruded by the screw extruder 26 as described in step S112. Under ever increasing atmospheric pressure the mixture is compressed causing rupturing. Furthermore, the temperature is caused to increase within the mixture resulting in an extruded mash 40 having an elevated temperature and pressure.

The hot oatmeal-like mixture is then conveyed to the pellet forming mechanism 30. The pellet forming mechanism 30 forms pellets having a predetermined size from the mixture as discussed in step S114. The hot pellets formed by the pellet forming mechanism 30 are conveyed to the cooler 34 wherein the temperature of the pellets is reduced to a predetermined level as described in step S116. The cooler 48 reduces the temperature of the pellets before conveying 50 the pelletized fuzzy cottonseed to the storage container 36. The palletized cottonseeds remain in the storage container until they are desired for use.

As shown in FIG. 5, the enriching of the cottonseed by the introduction of feed supplements, vitamins, and medicines can occur at one or more selected point depending on the properties that are to be attained. The enriching step S118 may be accomplished at any time after steps S106, S108, S110 and S112, e.g. the enriching can be performed at any time before palletizing. The infusion of additives and preservatives has an added advantage over coating in that the additives will permeate through the pellet. Because these additives are not subjected to atmospheric conditions such as UV rays, they may have a longer shelf life. Also the introduction of greater quantities of additives is possible that is not possible with coatings due to the fact that there is a finite surface area on a seed. The thicker the coating the greater chance of chipping and separation of the coating from the seed.

Furthermore, the pellets can be coated as a final process to protect the pellets from rodents and insects as discussed in step S120. This final coating would have little effect on the feed supplements, vitamins, and medicines that to a large extent are contained within the pellet. The step of coating, S120, occurs at any point after the cottonseeds are formed into pellets.

From the above description it can be seen that the method of producing palletized cottonseed of the present invention is able to overcome the shortcomings of prior art devices by providing a method of producing palletized cottonseed wherein at least a portion of the lint is removed from the whole cottonseed prior to extruding and replaced by a lesser grade of cotton fiber, the removed lint being preferably used in the production of cellulose based products. The method measures and controls the flow rate at which cottonseed moves from a storage device to a screw extruder and the screw extruder includes an input port for introducing a predetermined measured amount of cottonseed, an output port for extruding a predetermined measured amount of cottonseed, a bore having a diameter which decreases in size from the input port to the output portand a helical blade having a diameter which decreases in size from the input port to the output port for grinding the cottonseed into a blend mixture. The cottonseed blend temperature increases during passage from the input port to the output port of the screw extruder and the free cottonseed oil pigment gossypol binds with constituent cottonseed elements thereby reducing the amount of free gossypol. A pellet forming mechanism forms pellets from the cottonseed blend and includes an input port for introduction of the cottonseed blend and an output port for delivery of a palletized form of the cottonseed blend. The method may introduce nutritional ingredients into the blend creation process, the nutritional ingredients permeating throughout the blend pellet and/or apply coatings to cover the palletized cottonseed blend for protect the cottonseed against insect and vermin and extending the shelf life of the pellets. Furthermore, the method of producing palletized cottonseed of the present invention is simple and easy to use and economical in cost to manufacture.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. A method of producing pelletized whole fuzzy cottonseed from whole fuzzy cottonseed, the method comprising the steps of:
a) removing lint from the cottonseed;
b) adding cotton fibers to the cottonseed from which the lint was removed;
c) providing the cottonseed including the added cotton fibers to a screw extruder;
d) mincing the cottonseed including the added cotton fibers into a cottonseed mash in the screw extruder;
e) extruding the mash from the screw extruder; and
f) pelletizing the mash to form palletized cottonseeds.

2. The method of claim 1, wherein the step of removing lint removes between substantially 20 pounds and 240 pounds of lint.

3. The method of claim 1, wherein said step of adding cotton fibers adds at least one of gin waste, textile waste and low grade cotton fiber.

4. The method of claim 1 further comprising the step of storing the cottonseed in a holding bin prior to removing the lint.

5. The method of claim 1, further comprising the step of metering an amount of cottonseed being provided to the screw extruder.

6. The method of claim 1, further comprising the step of cooling the pelletized cottonseed.

7. The method of claim 1, further comprising the step of storing the pelletized and cooled cottonseed.

8. The method of claim 1, further comprising the step of enriching the cottonseed prior to pelletizing.

9. The method of claim 6, wherein the cottonseed is enriched with at least one of feed additives, vitamins and medicines.

10. The method of claim 1, further comprising the step of coating pelletized cottonseed.

11. The method of claim 10, wherein said step of coating coats the palletized cottonseeds with an insecticide for protecting the pelletized cottonseed from insects and rodents.

12. A system for producing pelletized whole fuzzy cottonseed from whole fuzzy cottonseed, said system comprising:
a) means for removing lint from the cottonseed;
b) means for adding cotton fibers to the cottonseed after the lint is removed;
c) means for mincing the cottonseed including the added cotton fibers into a cottonseed mash in the screw extruder; and
d) means for pelletizing the mash to form palletized cottonseeds.

13. The system of claim 12, wherein said means for removing lint removes between substantially 20 pounds and 240 pounds of lint.

14. The system of claim 12, wherein said means for adding cotton fibers adds at least one of gin waste, textile waste and low grade cotton fiber.

15. The system of claim 12, further comprising means for storing the cottonseed prior to removing the lint.

16. The system of claim 12, further comprising means for metering an amount of cottonseed provided to the screw extruder.

17. The system of claim 12, further comprising means for cooling the pelletized cottonseed.

18. The system of claim 12, further comprising means for storing the pelletized and cooled cottonseed.

19. The system of claim 12, further comprising means for enriching the cottonseed prior to pelletizing.

20. The system of claim 19, wherein the cottonseed is enriched with at least one of feed additives, vitamins and medicines.

21. The system of claim 12, further comprising means for the coating pelletized cottonseed.

22. The system of claim 21, wherein said pelletized cottonseeds are coated with an insecticide for protecting the palletized cottonseed from insects and rodents.
